(19) United States
(12) Patent Application Publication
(10) Pub. No.: US 2023/0077809 A1
(43) Pub. Date: Mar. 16, 2023

(54) SERVER, METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Kazushige SAKAI, Nagoya-shi (JP)

(73) Assignee: TOYOTA JIDOSHA KABUSHIKI KAISHA, Toyota-shi (JP)

(21) Appl. No.: 17/931,685

(22) Filed: Sep. 13, 2022

(30) Foreign Application Priority Data
Sep. 15, 2021 (JP) 2021-150654

(51) Int. Cl. G06Q 30/02; G08G 5/00

(52) U.S. Cl. CPC G06Q 30/0283; G08G 5/0039

(57) ABSTRACT

A server includes a controller configured to: acquire a service plan for a flight service by a flight object and meteorological information; calculate, based on the service plan and the meteorological information, a service probability that the flight service by the flight object will be performed; and set a fee for the flight service by the flight object based on the service probability.

### CROSS-REFERENCE TO RELATED APPLICATION

This application claims priority to Japanese Patent Application No. 2021-150654, filed on Sep. 15, 2021, the entire contents of which are incorporated herein by reference.

### TECHNICAL FIELD

The present disclosure relates to a server, a method, and a program.

### BACKGROUND

Technology for setting fees for products or services is known. For example, Patent Literature (PTL) 1 discloses technology for reflecting the presence or absence of an actual purchase of a product by a user and the user's satisfaction level at the product in calculation of the price of the product.

### CITATION LIST

Patent Literature

PTL 1: JP 2021-56578 A

### SUMMARY

There is room for improvement with respect to technology for setting fees for products or services. In particular, there is room for improvement with respect to technology for setting fees for flight services by flight objects.

It would be helpful to improve technology for setting fees for flight services by flight objects.

A server according to an embodiment of the present disclosure is a server including a controller configured to:

acquire a service plan for a flight service by a flight object and meteorological information;

calculate, based on the service plan and the meteorological information, a service probability that the flight service by the flight object will be performed; and

set a fee for the flight service by the flight object based on the service probability.

A method according to an embodiment of the present disclosure is a method performed by a server, the method including:

acquiring a service plan for a flight service by a flight object and meteorological information;

calculating, based on the service plan and the meteorological information, a service probability that the flight service by the flight object will be performed; and

setting a fee for the flight service by the flight object based on the service probability.

A program according to an embodiment of the present disclosure is a program configured to cause a computer to execute operations, the operations including:

acquiring a service plan for a flight service by a flight object and meteorological information;

calculating, based on the service plan and the meteorological information, a service probability that the flight service by the flight object will be performed; and

setting a fee for the flight service by the flight object based on the service probability.

According to an embodiment of the present disclosure, technology for setting fees for flight services by flight objects is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a flight object;

FIG. 3 is a block diagram illustrating a schematic configuration of a server;

FIG. 4 is a block diagram illustrating a schematic configuration of a terminal apparatus;

FIG. 5 is a flowchart illustrating a first example of operations of the server; and

FIG. 6 is a flowchart illustrating a second example of the operations of the server.

### DETAILED DESCRIPTION

Hereinafter, an embodiment of the present disclosure will be described.

### Outline of Embodiment

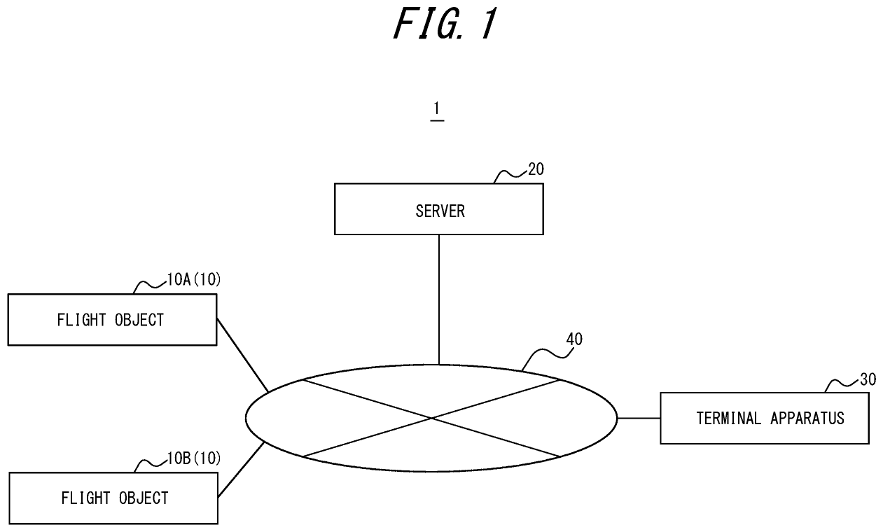

An outline of a system 1 according to an embodiment of the present disclosure will be described with reference to FIG. 1. FIG. 1 is a block diagram illustrating a schematic configuration of the system 1. The system 1 includes flight objects 10A and 10B, a server 20, and a terminal apparatus 30. Hereafter, when the flight objects 10A and 10B are not specifically distinguished, the flight objects 10A and 10B are simply referred to collectively as flight objects 10.

Each of the flight objects 10 is, for example, a Vertical Take-Off and Landing aircraft (VTOL) such as a vertical take-off and landing drone, but is not limited to this, and may be any flight object including a helicopter. Each of the flight objects 10 may be, for example, an electric flight object such as an electric Vertical Take-Off and Landing aircraft (eVTOL).

The server 20 is one computer or a plurality of computers in communication with each other. The terminal apparatus 30 is, for example, a computer such as a personal computer, a smartphone, or a tablet terminal apparatus.

For the sake of simplicity, FIG. 1 illustrates two of the flight objects 10, and one each of the server 20 and the terminal apparatus 30. However, the system 1 may include any number of flight objects 10, servers 20, and terminal apparatuses 30. The flight objects 10, the server 20, and the terminal apparatus 30 are communicably connected to a network 40 including, for example, the Internet, a mobile communication network, or the like.

First, an outline of the present embodiment will be described, and details thereof will be described later. The system 1 is used, for example, as a reservation system for flight services by the flight objects 10. The server 20 acquires a service plan for a flight service by the flight object 10 and meteorological information. The flight service by the flight object 10 is, for example, a service of flight from one point A to another point B to transport humans or cargo. However, the flight service by the flight object 10 may be any service that can be provided by flying the flight object 10. The server 20 calculates, based on the service plan and the meteorological information, a service probability that the flight service by the flight object 10 will be performed. The server 20 then sets a fee for the flight service by the flight object 10 based on the calculated service probability.

Thus, according to the present embodiment, it is possible to set the fee for the flight service by the flight object 10 based on the service probability that the flight service by the flight object 10 will be performed, which is calculated in consideration of the meteorological information. Therefore, technology for setting the fee for the flight service by the flight object 10 is improved in that the service probability of the flight service by the flight object 10, which is sensitive to meteorological conditions, can be reflected in the fee for the flight service by the flight object 10.

In the present embodiment, the flight object 10 is, for example, completely or partially operated under Visual Flight Rules (VFR). When the flight object 10 is under VFR, meteorological conditions significantly affect the service probability of the flight object 10, so it is beneficial to reflect the service probability calculated in consideration of the meteorological conditions in the fee for the flight service by the flight object 10. However, the flight object 10 may be operated under Instrument Flight Rules (IFR).

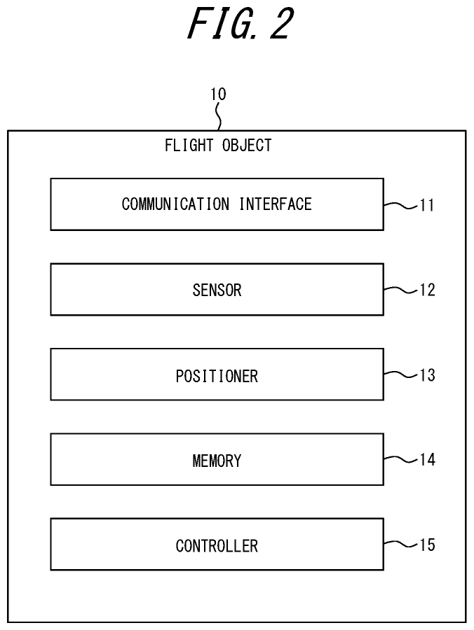

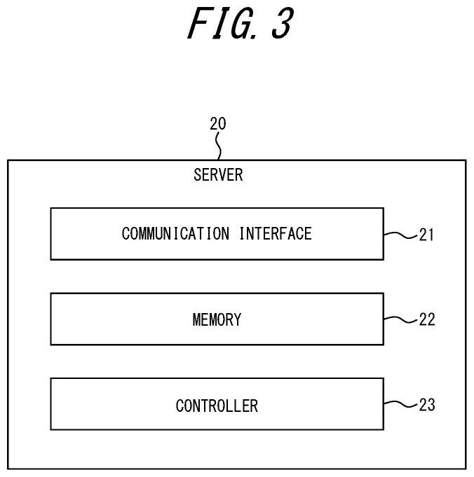

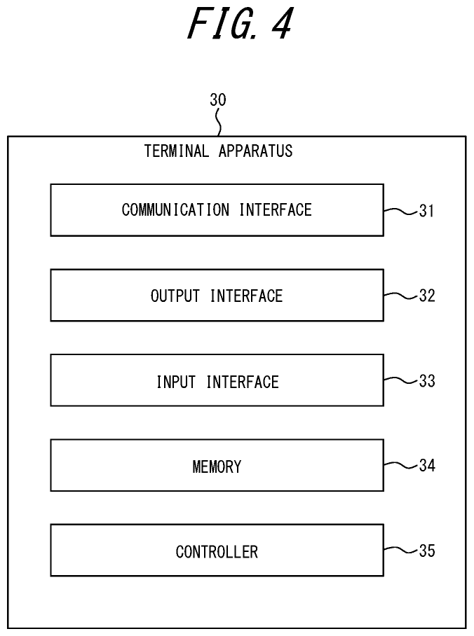

Next, with reference to FIGS. 2, 3, and 4, configurations of the system 1 will be explained in detail. FIG. 2 is a block diagram illustrating a schematic configuration of the flight object 10. FIG. 3 is a block diagram illustrating a schematic configuration of the server 20. FIG. 4 is a block diagram illustrating a schematic configuration of the terminal apparatus 30.

### Configuration of Flight Object

As illustrated in FIG. 2, the flight object 10 includes a communication interface 11, a sensor 12, a positioner 13, a memory 14, and a controller 15.

The communication interface 11 includes at least one communication interface for connecting to the network 40. The communication interface included in the communication interface 11 is compliant with mobile communication standards, such as the 4th generation (4G) standard or the 5th generation (5G) standard, for example, but is not limited to these, and may be compliant with any communication standard. In the present embodiment, the flight object 10 communicates with the server 20 via the communication interface 11 and the network 40. The flight object 10 may communicate with another computer than the server 20 according to the present embodiment via the communication interface 11 and the network 40.

The sensor 12 includes at least one sensor. The sensor 12 acquires meteorological information on a region where the flight object 10 is present. The sensor is, for example, a wind speed sensor, a wind direction sensor, an air temperature sensor, a barometric sensor, a humidity sensor, an illumination sensor, a precipitation sensor, a camera, or the like.

The positioner 13 measures the position of the flight object 10 and acquires positional information on the flight object 10. The positional information on the flight object 10 is, for example, coordinates such as the two-dimensional coordinates or three-dimensional coordinates of a spot where the flight object 10 is located. The positioner 13 measures the position of the flight object 10, for example, by navigation using a satellite positioning system or autonomous navigation. The positioner 13 includes a receiver corresponding to the satellite positioning system to measure the position of the flight object 10 by navigation using the satellite positioning system. The satellite positioning system to which the receiver corresponds may be, for example, the Global Positioning System (GPS). Alternatively, the positioner 13 may include a sensor such as an acceleration sensor or a gyro sensor, for measuring the position of the flight object 10 by autonomous navigation.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the flight object 10. For example, the memory 14 may store a system program, an application program, embedded software, and the like. The information stored in the memory 14 may be updated with, for example, information acquired from the network 40 via the communication interface 11.

The controller 15 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is, for example, an application specific integrated circuit (ASIC), but is not limited to this. The controller 15 controls operations of the entire flight object 10.

The controller 15 of the flight object 10 acquires the meteorological information on the region where the flight object 10 is present, and transmits the acquired meteorological information.

The controller 15 of the flight object 10 controls the sensor 12 to acquire the meteorological information on the region where the flight object 10 is present. The controller 15 may further control the positioner 13 to acquire the positional information on the flight object 10 at the time of acquisition of the meteorological information. The controller 15 may add the acquired positional information on the flight object 10 to the meteorological information on the region where the flight object 10 is present. The controller 15 of the flight object 10 transmits the meteorological information on the region where the flight object 10 is present to the server 20 via the communication interface 11 and the network 40.

### Configuration of Server

As illustrated in FIG. 3, the server 20 includes a communication interface 21, a memory 22, and a controller 23.

The communication interface 21 includes at least one communication interface for connecting to the network 40. The communication interface included in the communication interface 21 is compliant with, for example, mobile communication standards, wired local area network (LAN) standards, or wireless LAN standards, but is not limited to these, and may be compliant with any communication standards. In the present embodiment, the server 20 communicates with the flight objects 10 and the terminal apparatus 30 via the communication interface 21 and the network 40. The server 20 may communicate with another computer than the flight objects 10 and the terminal apparatus 30 according to the present embodiment via the communication interface 21 and the network 40. For example, the server 20 may communicate with another server that distributes meteorological information via the communication interface 21 and the network 40.

The memory 22 includes one or more memories. The memories included in the memory 22 may each function as, for example, a main memory, an auxiliary memory, or a cache memory. The memory 22 stores any information used for operations of the server 20. For example, the memory 22 may store a system program, an application program, a database, map information, and the like. The information stored in the memory 22 may be updated with, for example, information acquired from the network 40 via the communication interface 21.

The controller 23 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 23 controls operations of the entire server 20.

### Configuration of Terminal Apparatus

As illustrated in FIG. 4, the terminal apparatus 30 includes a communication interface 31, an output interface 32, an input interface 33, a memory 34, and a controller 35.

The communication interface 31 includes at least one communication interface for connecting to the network 40. The communication interface included in the communication interface 31 is compliant with mobile communication standards, such as the 4G standard or the 5G standard, for example, but is not limited to these, and may be compliant with any communication standard. In the present embodiment, the terminal apparatus 30 communicates with the server 20 via the communication interface 31 and the network 40. The terminal apparatus 30 may communicate with another computer than the server 20 according to the present embodiment via the communication interface 31 and the network 40.

The output interface 32 includes at least one output apparatus. The output apparatus included in the output interface 32 is, for example, a display, a speaker, or the like. The output interface 32 outputs information in the form of images, sound, or the like.

The input interface 33 includes at least one input apparatus. The input apparatus included in the input interface 33 may be, for example, a touch panel, a camera, a microphone, an IC card reader, or the like. The input interface 33 accepts input operations by a user.

The memory 34 includes one or more memories. The memories included in the memory 34 may each function as, for example, a main memory, an auxiliary memory, or a cache memory. The memory 34 stores any information to be used for operations of the terminal apparatus 30. For example, the memory 34 may store a system program, an application program, embedded software, or the like. The information stored in the memory 34 may be updated with, for example, information acquired from the network 40 via the communication interface 31.

The controller 35 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 35 controls operations of the entire terminal apparatus 30.

### Flow of Operations of Server

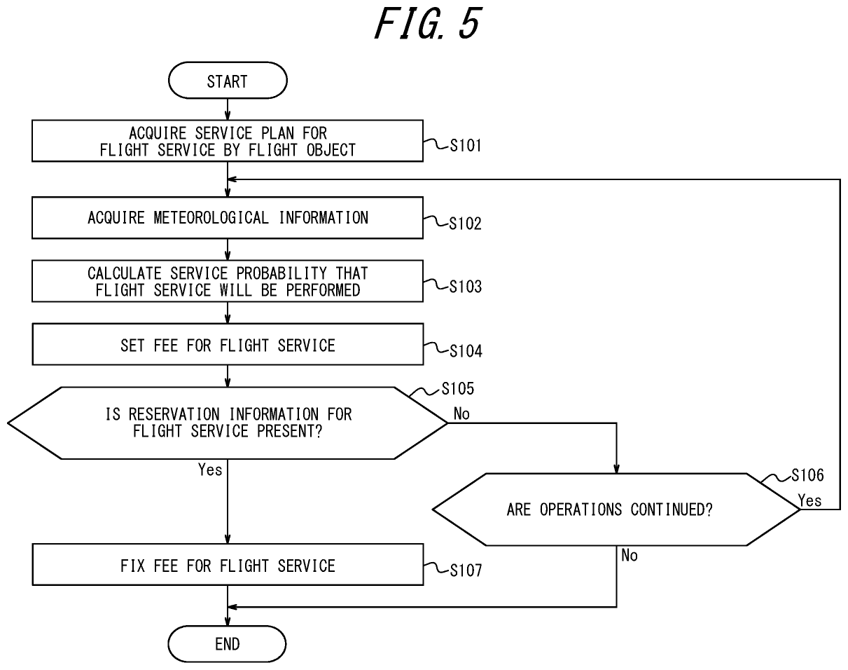

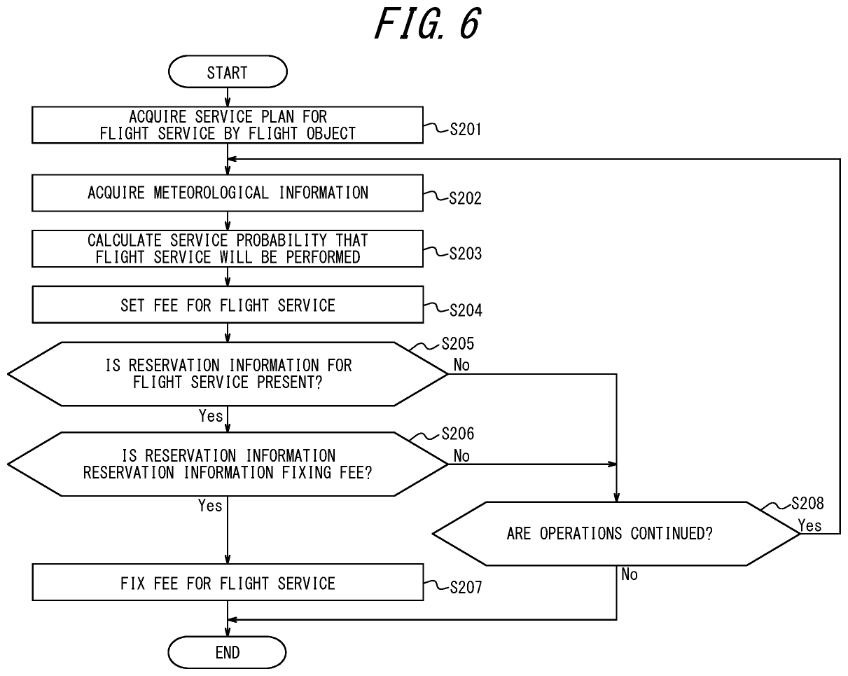

With reference to FIGS. 5 and 6, operations of the server 20 in the system 1 according to the present embodiment will be described. FIG. 5 is a flowchart illustrating a first example of the operations of the server 20. FIG. 6 is a flowchart illustrating a second example of the operations of the server 20. These operations correspond to a method performed by the server 20 according to the present embodiment.

### First Example of Operations of Server

With reference to FIG. 5, the first example of the operations of the server 20 in the system 1 according to the present embodiment will be described. In the description of this example of the operations, the system 1 is a reservation system for flight services by the flight objects 10. In the system 1, the server 20 repeatedly acquires meteorological information, and dynamically updates a fee for a flight service by the flight object 10A. In this example of the operations, the server 20 stops updating the fee of the flight service, upon acquiring reservation information for the flight service. In the description of this example of the operations, it is assumed that the other flight object 10B is flying in a region associated with a service plan for the flight service by the flight object 10A.

Step S101: The controller 23 of the server 20 acquires a service plan for a flight service by the flight object 10A.

The service plan for the flight service by the flight object 10A includes, for example, geographic information and/or temporal information associated with the flight service by the flight object 10A. The geographic information includes, for example, a region where the flight object 10A is to fly in the flight service, such as a departure point, a destination, a flight route, or a flight altitude. The temporal information includes, for example, a season, a date, a time period, or the like when the flight service is to be performed.

Any method can be employed to acquire the service plan for the flight service by the flight object 10A. For example, the controller 23 may read the service plan for the flight service by the flight object 10A that is previously stored in the memory 22. Alternatively, the controller 23 may receive the service plan for the flight service by the flight object 10A from another server that manages the service plan.

Step S102: The controller 23 of the server 20 acquires meteorological information.

The meteorological information includes, for example, weather, wind speed, wind direction, temperature, barometric pressure, humidity, precipitation, fog density, or the like. More specifically, the meteorological information includes meteorological forecast information during the time period when the flight service by the flight object 10A is to be performed, for the region where the flight service by the flight object 10A is to fly, based on the service plan for the flight service by the flight object 10A.

Any method can be employed to acquire the meteorological information. For example, the controller 23 may receive, via the communication interface 21 and the network 40, meteorological information from another server that distributes the meteorological information. The controller 23 may store the meteorological information received from the other server as is in the memory 22, as meteorological information associated with the service plan for the flight service by the flight object 10A.

Alternatively, for example, the controller 23 may receive, via the communication interface 21 and the network 40, meteorological information on a region where the other flight object 10B is present that has been acquired by the flight object 10B flying in the region associated with the service plan for the flight service by the flight object 10A. That is, the meteorological information may include the meteorological information acquired by the other flight object 10B that is flying in the region associated with the service plan for the flight service by the flight object 10A. There may be a plurality of the other flight objects 10B that are flying in the region associated with the service plan for the flight service by the flight object 10A.

The controller 23 may generate the meteorological information associated with the service plan for the flight service by the flight object 10A using the meteorological information acquired by the other flight object 10B in addition to/instead of the meteorological information received from the other server. For example, the controller 23 may correct, using the meteorological information acquired by the other flight object 10B, the meteorological forecast information during the time period when the flight service by the flight object 10A is to be performed and for the region where the flight service by the flight object 10A is to fly, which is received from the other server, in order to generate the meteorological information associated with the service plan for the flight service by the flight object 10A. Thereby, the use of the meteorological information acquired by the other flight object 10B that is actually flying in the region where the flight service by the flight object 10A is to be performed improves the accuracy of the meteorological information associated with the service plan for the flight service by the flight object 10A, which in turn improves accuracy in calculation of a service probability that the flight service by the flight object 10A will be performed, as described later. The controller 23 may store in the memory 22 the generated meteorological information associated with the service plan for the flight service by the flight object 10A.

Step S103: The controller 23 of the server 20 calculates the service probability that the flight service by the flight object 10A will be performed, based on the service plan and the meteorological information.

The service probability that the flight service will be performed may be, for example, a probability that the flight service will start as planned without being cancelled or postponed. Alternatively, the service probability for the flight service may be a probability that the flight service will start and end as planned. Failure to end the flight service as planned includes, for example, change in the flight route or an estimated arrival time, turning back to the departure point, change of the destination, travel to the destination using an alternative means of transportation such as a cab en route to the destination, and the like, due to worsening meteorological conditions.

Any appropriate method can be employed to calculate the service probability. For example, the controller 23 may store in advance in the memory 22 a correspondence algorithm between the service plan and meteorological conditions in which the flight service by the flight object 10A is to be performed and the service probability. The controller 23 may calculate, using the correspondence algorithm, the service probability that the flight service by the flight object 10A will be performed, based on the service plan and the meteorological information.

For example, the correspondence algorithm may be set up to calculate a lower service probability when the departure point or destination included in the service plan is a rooftop of a building, because the rooftop of the building is more susceptible to meteorological conditions than when the departure point or destination is an airport. For example, the correspondence algorithm may be set up to calculate a lower service probability, the higher a predicted value of the wind speed in the flight route included in the service plan.

The correspondence algorithm may be set up by a statistical method such as machine learning or deep learning. For example, the correspondence algorithm may be set up by the statistical method, based on service plans and meteorological conditions of flight services by the one or more flight objects 10 stored in the server 20 and results of whether the flight services are each performed.

Step S104: The controller 23 of the server 20 sets a fee for the flight service by the flight object 10A based on the service probability.

Any method can be employed to set the fee for the flight service. For example, the controller 23 may store, in the memory 22, a base fee and a variable fee for the flight service by the flight object 10A based on the service plan. For example, the base fee may be a minimum pric e at least above a break-even point for the flight service, taking into account fuel or labor costs. The controller 23 may vary the variable fee based on the service probability. The controller 23 may set, as the fee for the flight service, the sum of the base fee and the variable fee that is varied according to the service probability. The controller 23 may transmit the set fee for the flight service by the flight object 10A to the user's terminal apparatus 30 via the communication interface 21 and the network 40.

The controller 23 may set a lower fee for the flight service by the flight object 10A, the lower the service probability of the flight service by the flight object 10A. Specifically, the controller 23 sets a lower variable fee, the lower the service probability. Thereby, the risk of being unable to perform the flight service by the flight object 10A can be reflected in the fee. In addition, lowering the fee for the flight service, in the case of presence of the risk of being unable to perform the flight service by the flight object 10A, contributes to improvement in customer satisfaction with the flight service by the flight object 10A, whose service probability is apt to decrease depending on meteorological conditions, and also to reduction in opportunity loss by increasing a reservation rate.

Step S105: The controller 23 of the server 20 determines whether reservation information for the flight service by the flight object 10A is present. Here, the reservation information for the flight service is information indicating that the flight service is reserved by any user.

Any method can be employed to determine whether the reservation information for the flight service is present. For example, the controller 23 may receive, via the communication interface 21 and the network 40, the reservation information for the flight service by the flight object 10A from the terminal apparatus 30 used by the user. Alternatively, the controller 23 may receive, via the communication interface 21 and the network 40, the reservation information for the flight service by the flight object 10A from another server managing the reservation information. The controller 23 may store the received reservation information in the memory 22.

Step S106: In a case in which the controller 23 of the server 20 determines that no reservation information is present (S105: NO), the controller 23 of the server 20 determines whether to continue the operations.

Any appropriate method can be adopted to determine whether to continue the operations. For example, the controller 23 may determine whether to continue the operations, based on whether a current time is beyond a predetermined time. The predetermined time may be, for example, a start time of the flight service by the flight object 10A, or a time set based on the start time. The controller 23 may determine to continue the operations in a case in which the current time is not beyond the predetermined time.

In a case in which the controller 23 determines to continue the operations (S106: YES), the controller 23 repeats processing from step S102. Specifically, the controller 23 repeatedly acquires the meteorological information. Upon acquiring the new meteorological information, the controller 23 updates the service probability that the flight service by the flight object 10A will be performed, based on the service plan and the new meteorological information. The controller 23 updates the fee for the flight service by the flight object 10A based on the updated service probability. Therefore, the controller 23 can dynamically update the fee for the flight service to an appropriate value according to a change in the meteorological information, until a reservation for the flight service is made or until a time period available for a reservation for the flight service has passed. The controller 23 may transmit the updated fee for the flight service by the flight object 10A to the user's terminal apparatus 30 via the communication interface 21 and the network 40.

On the other hand, in a case in which the controller 23 determines not to continue the operations (S106: NO), the controller 23 ends the operations. The controller 23 may transmit via the communication interface 21 and the network 40 to the user's terminal apparatus 30 that acceptance of a reservation for the flight service has been closed.

Step S107: In a case in which the controller 23 of the server 20 determines that the reservation information is present (S105: YES), the controller 23 of the server 20 does not update the fee for the flight service by the flight object 10A. Thereby, the controller 23 may fix the fee for the flight service. The controller 23 may transmit the fixed fee for the flight service by the flight object 10A to the user's terminal apparatus 30 via the communication interface 21 and the network 40. The controller 23 then ends the operations.

Fixing the fee for the flight service when the flight service is booked, as in this example of the operations, prevents placing the user of the service at the disadvantage that the fee increases due to a change in the meteorological conditions after booking. Therefore, the system 1 can encourage the user to actively book the flight service when the user himself/herself judges the fee to be an appropriate price. According to this configuration, customer satisfaction with the flight service by the flight object 10A, which is apt to decrease due to the meteorological conditions, can be further improved, and opportunity loss can be further reduced by increasing a reservation rate. On the other hand, by fixing the fee for the flight service when the flight service is booked, as in this example of the operations, a service provider can fix revenue before the flight service starts, and even in a case in which the flight service cannot be performed due to bad meteorological conditions, the service provider can have revenue from a cancellation fee and other sources. Therefore, the system 1 is advantageous for flight services by flight objects with low service probabilities.

### Second Example of Operations of Server

Next, with reference to FIG. 6, the second example of the operations of the server 10 in the system 1 according to the present embodiment will be described.

The second example of the operations differs from the first example of the operations in that, even after the reservation information for the flight service is acquired, whether to continue further updating the fee for the flight service is determined. The second example of the operations will be described below, focusing on the point that is different from the first example of the operations. In the description of this operations, it is also assumed that the other flight object 10B is flying in a region associated with a service plan for a flight service by the flight object 10A.

Step S201: Similar to step S101, the controller 23 of the server 20 acquires a service plan for a flight service by the flight object 10A.

Step S202: Similar to step S102, the controller 23 of the server 20 acquires meteorological information.

Step S203: Similar to step S103, the controller 23 of the server 20 calculates, based on the service plan and the meteorological information, a service probability that the flight service by the flight object 10A will be performed.

Step S204: Similar to step S104, the controller 23 of the server 20 sets a fee for the flight service by the flight object 10A based on the service probability.

Step S205: Similar to step S105, the controller 23 of the server 20 determines whether reservation information for the flight service by the flight object 10A is present.

Here, as in the first example of the operations, the reservation information is information indicating that the flight service is reserved by any user. Furthermore, in this example of the operations, the reservation information includes reservation information fixing the fee at the time of booking the flight service and reservation information not fixing the fee. The reservation information fixing the fee for the flight service at the time of booking the flight service is hereinafter also referred to simply as “reservation information fixing the fee”.

Step S206: In a case in which the controller 23 of the server 20 determines that the reservation information is present (S205: YES), the controller 23 further determines whether the reservation information is the reservation information fixing the fee.

Any method can be employed to determine whether the reservation information for the flight service is the reservation information fixing the fee. For example, the controller 23 may make the determination based on whether the reservation information for the flight service by the flight object 10A received from the terminal apparatus 30 used by the user or another server includes information indicating that the reservation information is the reservation information fixing the fee.

Step S207: In a case in which the controller 23 of the server 20 determines that the reservation information is the reservation information fixing the fee (S206: YES), the controller 23 fixes the fee for the flight service. The controller 23 may transmit the fixed fee for the flight service by the flight object 10A to the user's terminal apparatus 30 via the communication interface 21 and the network 40. The controller 23 then ends the operations.

Step S208: In a case in which the controller 23 of the server 20 determines that no reservation information is present (S205: NO) or that the reservation information is not the reservation information fixing the fee (S206: NO), as in step S106, the controller 23 determines whether to continue the operations. For example, the controller 23 may determine whether to continue the operations, based on whether a current time is beyond a predetermined time. The predetermined time may be, for example, a start time of the flight service by the flight object 10A, or a time set based on the start time.

In a case in which the controller 23 determines to continue the operations (S208: YES), the controller 23 repeats processing from step S202. In other words, even in a case in which the controller 23 determines that the reservation information is present, when the reservation information is not the reservation information fixing the fee, the controller 23 updates the fee for the flight service by the flight object 10A. Specifically, the controller 23 repeatedly acquires the meteorological information. Upon acquiring the new meteorological information, the controller 23 updates the service probability that the flight service by the flight object 10A will be performed, based on the service plan and the new meteorological information. The controller 23 updates the fee for the flight service by the flight object 10A based on the updated service probability. This allows the controller 23 to dynamically update the fee for the flight service to an appropriate value according to a change in the meteorological information. The controller 23 may transmit the updated fee for the flight service by the flight object 10A to the user's terminal apparatus 30 via the communication interface 21 and the network 40.

On the other hand, in a case in which the controller 23 determines not to continue the operations (S208: NO), the controller 23 ends the operations. The controller 23 fixes the fee for the flight service when the reservation information is present. The controller 23 may transmit, to the user's terminal apparatus 30 via the communication interface 21 and the network 40, that acceptance of a reservation for the flight service has been closed or that the fee for the flight service has been fixed.

By dynamically updating the fee for the flight service according to changes in meteorological conditions, for example, until a start of the flight service, even after the flight service is booked, as in this example of the operations, the price of the flight service for the the flight object 10A, which is sensitive to the meteorological conditions, can be set to an appropriate value, both for a service provider and for the user. As in this example of the operations, the system 1 can also provide the user of the flight service with the option of fixing the fee for the flight service or not fixing the fee at the time of booking the flight service. This further improves customer satisfaction with the flight service.

As described above, the server 20 according to the present embodiment acquires the service plan for the flight service by the flight object 10 and the meteorological information. The server 20 calculates, based on the service plan and the meteorological information, the service probability that the flight service by the flight object 10 will be performed. The server 20 then sets the fee for the flight service by the flight object 10 based on the calculated service probability.

According to this configuration, the fee for the flight service by the flight object 10 can be set based on the service probability that the flight service by the flight object 10 will be performed, which is calculated in consideration of the meteorological information. Therefore, technology for setting the fee for the flight service by the flight object 10 is improved in that the service probability of the flight service by the flight object 10, which is sensitive to meteorological conditions, can be reflected in the fee for the flight service by the flight object 10.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which a general purpose computer functions as the server 20 according to the above embodiment can also be implemented. Specifically, a program in which processes for realizing the functions of the server 20 according to the above embodiment are written may be stored in a memory of the general purpose computer, and the program may be read and executed by a processor. Accordingly, the present disclosure can also be implemented as a program executable by a processor, or a non-transitory computer readable medium storing the program.

1. A server comprising a controller configured to:
acquire a service plan for a flight service by a flight object and meteorological information;
calculate, based on the service plan and the meteorological information, a service probability that the flight service by the flight object will be performed; and
set a fee for the flight service by the flight object based on the service probability.

2. The server according to claim 1, wherein the service plan includes geographic information and/or temporal information associated with the flight service by the flight object.

3. The server according to claim 1, wherein the meteorological information includes meteorological information acquired by another flight object flying in a region associated with the service plan for the flight service by the flight object.

4. The server according to claim 1, wherein the controller sets a lower fee for the flight service by the flight object, the lower the service probability of the flight service by the flight object.

5. The server according to claim 1, wherein the controller is configured to:
repeatedly acquire the meteorological information;
upon acquiring new meteorological information, update, based on the service plan and the new meteorological information, the service probability that the flight service by the flight object will be performed;
and update the fee for the flight service by the flight object based on the updated service probability.

6. The server according to claim 5, wherein the controller is configured to determine whether reservation information for the flight service by the flight object is present, and in a case in which the reservation information is determined to be present, the controller does not update the fee for the flight service by the flight object.

7. The server according to claim 6, wherein even in a case in which the reservation information is determined to be present, the controller updates the fee for the flight service by the flight object when the reservation information is not reservation information fixing the fee.

8. A method performed by a server, the method comprising:
acquiring a service plan for a flight service by a flight object and meteorological information;
calculating, based on the service plan and the meteorological information, a service probability that the flight service by the flight object will be performed; and
setting a fee for the flight service by the flight object based on the service probability.

9. The method according to claim 8, wherein the service plan includes geographic information and/or temporal information associated with the flight service by the flight object.

10. The method according to claim 8, wherein the meteorological information includes meteorological information acquired by another flight object flying in a region associated with the service plan for the flight service by the flight object.

11. The method according to claim 8, wherein the setting of the fee includes setting a lower fee for the flight service by the flight object, the lower the service probability of the flight service by the flight object.

12. The method according to claim 8, further comprising:
repeatedly acquiring the meteorological information;
upon acquiring new meteorological information, updating, based on the service plan and the new meteorological information, the service probability that the flight service by the flight object will be performed; and
updating the fee for the flight service by the flight object based on the updated service probability.

13. The method according to claim 12, further comprising:
determining whether reservation information for the flight service by the flight object is present; and
in a case in which the reservation information is determined to be present, not updating the fee for the flight service by the flight object.

14. The method according to claim 13, further comprising, even in a case in which the reservation information is determined to be present, updating the fee for the flight service by the flight object when the reservation information is not reservation information fixing the fee.

15. A non-transitory computer readable medium storing a program configured to cause a computer to execute operations, the operations comprising:
acquiring a service plan for a flight service by a flight object and meteorological information;
calculating, based on the service plan and the meteorological information, a service probability that the flight service by the flight object will be performed; and
setting a fee for the flight service by the flight object based on the service probability.

16. The non-transitory computer readable medium according to claim 15, wherein the service plan includes geographic information and/or temporal information associated with the flight service by the flight object.

17. The non-transitory computer readable medium according to claim 15, wherein the meteorological information includes meteorological information acquired by another flight object flying in a region associated with the service plan for the flight service by the flight object.

18. The non-transitory computer readable medium according to claim 15, wherein the setting of the fee includes setting a lower fee for the flight service by the flight object, the lower the service probability of the flight service by the flight object.

19. The non-transitory computer readable medium according to claim 15, wherein the operations further comprise:
repeatedly acquiring the meteorological information;
upon acquiring new meteorological information, updating, based on the service plan and the new meteorological information, the service probability that the flight service by the flight object will be performed;
and updating the fee for the flight service by the flight object based on the updated service probability.

20. The non-transitory computer readable medium according to claim 19, wherein the operations further comprise:
determining whether reservation information for the flight service by the flight object is present; and
in a case in which the reservation information is determined to be present, not updating the fee for the flight service by the flight object.
